(19) United States
(12) Patent Application Publication
(10) Pub. No.: US 2011/0248497 A1
(43) Pub. Date: Oct. 13, 2011

(54) Pressure-Energized Probe Seal for Female Hydraulic Coupling Member

(75) Inventor: Robert E. Smith, III, Missouri City, TX (US)

(73) Assignee: National Coupling Company, Inc., Stafford, TX (US)

(21) Appl. No.: 12/757,504

(22) Filed: Apr. 9, 2010

(51) Int. Cl. F16L 21/02; F16J 15/02

(52) U.S. Cl. 285/374; 277/627

(57) ABSTRACT

A crown-type probe seal for a female hydraulic coupling member has one or more pressure-energized seals for sealing between the probe seal and the body of the coupling member which retains the probe seal. The generally ring-shaped probe seal has an annular fluid chamber in at least one end of the body of the seal. Hydraulic fluid under pressure may enter the annular fluid chamber and exert a generally radial force in response to a pressure differential. This radial force can act to increase the sealing effectiveness of the probe seal to the body of the female coupling member having such a probe seal.

### CROSS-REFERENCE TO RELATED APPLICATIONS

None

### STATEMENT REGARDING FEDERALLY SPONSORED RESEARCH OR DEVELOPMENT

Not Applicable

### BACKGROUND OF THE INVENTION

1. Field of the Invention

This invention relates to hydraulic coupling members. More particularly, it relates to high-pressure, female coupling members for subsea use in oil and gas exploration and production applications.

2. Description of the Related Art Including Information Disclosed Under 37 CFR 1.97 and 1.98.

A wide variety of hydraulic coupling members are known in the art. Typically, a coupling is comprised of two members—a male member having a generally cylindrical probe and a female member having a receiving chamber equipped with one or more seals for providing a fluid-tight seal with the outer surface of the probe element of the male member.

For high-temperature, high-pressure applications, a probe seal having a dovetail interlocking fit with the body of a female coupling member has proven to be a particularly effective configuration. In certain coupling members, the probe seal has a dovetail interlocking fit with a seal retainer or seal cartridge in the female coupling member.

U.S. Pat. Nos. 5,099,882 and 5,203,374 disclose a pressure balanced hydraulic coupling with a variety of seals having a dovetail interlocking fit that prevents radial movement of the seal into the bore. This pressure balanced coupling has radial passageways communicating between the male and female members such that substantial fluid pressure is not exerted against the face of either member during coupling or uncoupling or during the coupled state. Radial passageways in the male and female members match up at their longitudinal surfaces so that fluid pressure between the male and female members is in a substantially radial direction and is not exerted at the face of either member. A first pair of seals is positioned on each side of the radial passage for sealing between the receiving chamber and the seal retainer. A second pair of seals is positioned on each side of the radial passage for sealing between the seal retainer and the male member.

U.S. Pat. No. 5,390,702 discloses an undersea hydraulic coupling having a male member with a stepped outer body that is inserted into a female member having a bore with stepped internal cylindrical surface. The step in the male member defines first and second external cylindrical surfaces which are slidably received in the female member bore and in a sleeve member before the seals, which are retained by the sleeve member, engage the male member. Thus, the male member is more accurately positioned and guided into the seals, insuring greater seal reliability and longer seal life. The stepped surfaces also help prevent implosion of the seals due to sea pressure when the end of the male member comes out of the seals.

U.S. Pat. No. 6,123,103 discloses another pressure balanced hydraulic coupling for use in undersea drilling and production operations which is equipped with dovetail type seals. The female member has a split body with a first part and a second part, each having a longitudinal passage and a radial fluid passage. A radial seal is positioned on the junction between the first and second parts of the female member body to facilitate removal and replacement of the radial seal when the split body is disassembled. The male member may be inserted through the first and second parts of the female coupling member, thereby establishing fluid communication between the coupling members in a direction transverse to the coupling member bores.

U.S. Pat. No. 6,206,040 discloses another undersea hydraulic coupling with seals having a dovetail profile. This undersea hydraulic coupling has a stepped internal bore dimensioned to increase the flow rate through the coupling. The coupling allows an increased flow rate without increasing the size or weight of the coupling by positioning the poppet valve in the body section, rather than in the probe section, of the male coupling member.

U.S. Pat. No. 6,575,430 discloses an undersea hydraulic coupling member having a ring-shaped seal with multiple sealing surfaces that extend inwardly from the inner surface in a radial direction. The multiple sealing surfaces help guide the probe of the male coupling member into the female member without the risk of drag or galling of the receiving chamber or metal seal retained therein. The seal has reverse inclined shoulders which provide an interlocking fit in the female member to restrain the seal from moving radially inwardly due to vacuum or low pressure in the receiving chamber.

U.S. Pat. No. 4,190,259 describes a single apex, two element fluid pressure seal assembly that has a convergingly tapered surface defining a central vertex or apex that projects radially from the seal body. The vertex creates a narrow contact dynamic seal area between the apex and the surface of an adjacent machined part. Seals of this type are available from Macrotech Polyseal, Inc. (Salt Lake City, Utah 84126) under the CROWN SEAL® brand name.

U.S. Pat. No. 6,179,002 describes an undersea hydraulic coupling with a pressure-energized dovetail seal. The seal has a pair of flexible sealing surfaces for sealing with the male and female coupling members, and a cavity therebetween that is exposed to fluid pressure in the coupling. The outer circumference of the seal has a dovetail interfit between inclined shoulders in the female member bore and on a seal retainer that holds the seal in the bore.

U.S. Pat. Nos. 5,052,439 and 4,900,071 describe an undersea hydraulic coupling which includes a male member and female member, and a two-piece retainer for restraining radial movement of a wedge-shaped annular seal into the central bore of the female member. The two-piece retainer includes a cylindrical retainer sleeve member slidably received within the female member bore, and a threaded retainer-locking member threadable to mating threads in the wall of the central bore. The retainer-locking member holds the retainer sleeve member in place within the female member bore. The annular seal is restrained from radial movement by a dovetail interlocking fit with a mating shoulder on at least one of the retainer sleeve and the retainer-locking members.

U.S. Patent Publication Nos. 2009/0273144 A1 and 2009/0273181 A1 disclose probe seals for a female hydraulic coupling member that have one or more circumferential pressure-energized seals for sealing between the probe seal and the body of the coupling member. An annular cavity in the side wall of the probe seal is open to the outer cylindrical surface of the generally ring-shaped probe seal. Hydraulic fluid, under pressure, can enter the annular cavity through the opening and exert a radial force on sealing elements. In certain embodiments, the annular cavity is generally L-shaped in cross section; in other embodiments, the annular cavity is generally T-shaped in cross section. In some embodiments, a pressure differential also imparts an inwardly-directed radial force to the crown seal.

### BRIEF SUMMARY OF THE INVENTION

A crown-type probe seal for a female hydraulic coupling member has one or more pressure-energized seals for sealing between the body of the probe seal and the body of a coupling member which retains the probe seal. The generally ring-shaped probe seal has an annular fluid chamber in at least one end wall of the body of the seal. Hydraulic fluid under pressure may enter the annular fluid chamber and exert a generally radial force in response to a pressure differential. This radial force can act to increase the sealing effectiveness of the probe seal to the body of the female coupling member having such a probe seal. In “negative pressure” situations (i.e., when the ambient pressure exceeds the internal fluid pressure), seawater may enter an annular fluid chamber on the opposing end of the probe seal and similarly act to increase the sealing effectiveness of the probe seal to the body of the female coupling member.

### BRIEF DESCRIPTION OF THE SEVERAL VIEWS OF THE DRAWING(S)

FIG. 1 is a cross-sectional view of female hydraulic coupling equipped with a probe seal according to a first embodiment.

FIG. 2 is a cross-sectional view of a pressure-energized probe seal according to a first embodiment.

FIG. 2A is an enlarged view of the portion of the probe seal indicated in FIG. 2.

FIG. 3 is a cross-sectional view of a pressure-energized probe seal according to a second embodiment.

FIG. 4 is a cross-sectional view of a pressure-energized probe seal according to a third embodiment.

### DETAILED DESCRIPTION OF THE INVENTION

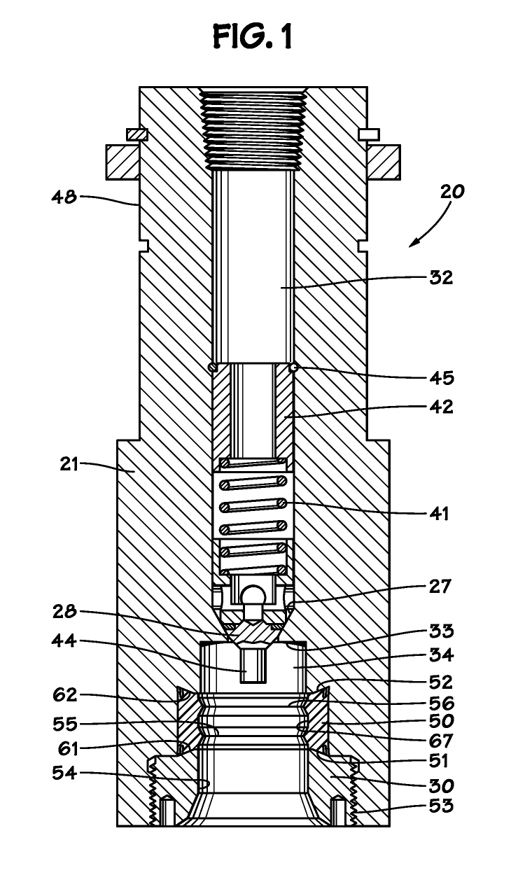

The invention may best be understood by reference to particular embodiments. As shown in FIG. 1, female hydraulic coupling member 20 comprises body 21, handle 48 which may be inserted in a manifold plate, and central bore 32 which has several variations in its diameter as it extends through the female member. The first end of the bore may be internally threaded for connection to a hydraulic line. Other connection means known in the art may be utilized including welding, swaging, compression fittings, and the like. A cylindrical passageway extends longitudinally within the female member body and terminates at valve seat 27. Shoulder 33 is adjacent valve seat 27 and forms one end of receiving chamber 34.

The female member 20 may include optional poppet valve 28 which is sized to slide within the cylindrical passageway. The poppet valve may be conical in shape and is urged by valve spring 41 into a seated position against valve seat 27. When the poppet valve is in a closed position against the valve seat, it seals fluid from flowing between the male member and the female member. Hollow spring collar 42 anchors the valve spring 41 and is held in place by collar clip 45. Actuator 44 extends from the apex of the poppet valve.

Ring-shaped seal 50 is positioned in the receiving chamber of the female member. The ring-shaped seal may be an elastomer or polymer seal that is flexible and resilient. In other embodiments, seal 50 may be fabricated from an engineering plastic such as polyetheretherketone (PEEK). Seal 50 has a first inclined shoulder surface 52 and a second inclined shoulder surface 51. The axial dimension of the elastomeric seal at its outer circumference is greater than the axial dimension of the seal at inner circumference 67. The seal thus has a generally wedge-shaped cross section. Seal 50 may have one or more radial sealing surfaces 55, 56 extending inwardly from the seal's inner circumference 67. Each of the radial sealing surfaces extends inwardly from the inner circumference so as to engage the probe of the male member when the probe is inserted through the seal. The radial sealing surfaces may be elastically deformed by the probe when it is inserted through the seal. The radial sealing surfaces 55 and 56 provide guide points to help align and guide the probe of the male member when it is inserted through the seal and into the receiving chamber 34.

In the female coupling member shown in FIG. 1, implosion of the seal into the receiving chamber due to low pressure or vacuum is resisted because the seal has an interlocking fit with reverse inclined shoulder surface 62 of the central bore and reverse inclined shoulder surface 61 of locking member 30.

Reverse inclined shoulder 62 is situated between the first and second internal circumferential surfaces. The reverse inclined shoulder has an interlocking fit with seal 50 to restrain the seal from moving inwardly in a radial direction.

In the illustrated coupling, locking member 30 engages the female coupling member with threads 53. Other engaging means known in the art may be used. The locking member 30 has a central opening with an internal diameter 54 that allows insertion of the probe of the male member. Reverse inclined shoulder surface 61 holds seal 50 in place and restrains the seal from moving inward in a radial direction.

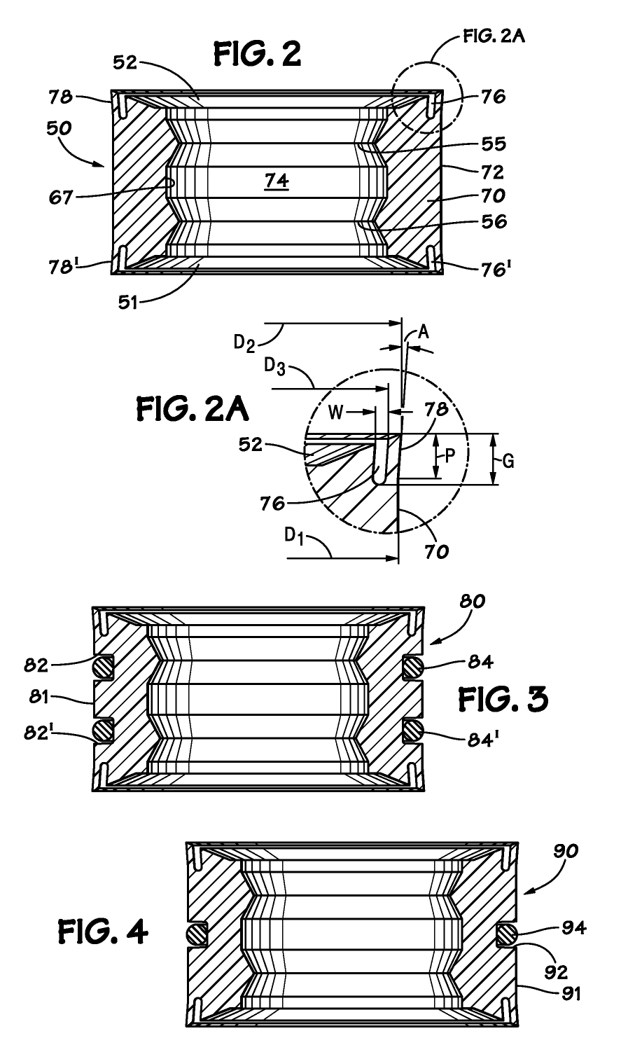

FIG. 2 shows probe seal 50 according to a first embodiment of the invention. Probe seal 50 is a generally cylindrical body 70 having a central bore 74 dimensioned to receive the probe of a corresponding male hydraulic coupling member. Ring-shaped body 70 has beveled shoulder 51 on a first end thereof and opposing beveled shoulder 52 on a second end. Beveled shoulders 51 and 52 enable probe seal 50 to have a dovetail interlocking fit with body 21 and locking member 30 of a female hydraulic coupling member (such as that illustrated in FIG. 1). The dovetail interlocking fit resists inward radial movement of probe seal 50 in response to reduced pressure in the receiving chamber of the female coupling member such as may occur during withdrawal of the probe of a male coupling member.

One or more radial sealing projections 55,56 extend from inner circumference 67 of ring-shaped body 70 and may be sized and spaced to seal against the outer circumference of a generally cylindrical probe of a corresponding male coupling member. In the illustrated embodiments, sealing projections 55 and 56 are generally triangular in cross section. Sealing projections 55 and 56 may have other configurations including, but not limited to, pressure-energized configurations such as are disclosed in U.S. Pat. No. 6,575,430 to Robert E. Smith, III.

The ends of ring-shaped body 70 have an annular groove 76 open to an end surface of generally cylindrical body 70. Hydraulic fluid, under pressure, can enter one or both of grooves 76,76′ through the open end of the groove. Inasmuch as the distal portion of seal 50 is substantially at ambient pressure (typically, a lower pressure than that of the hydraulic fluid), a pressure differential is established which exerts an outward, radial force on sealing surface 78. This force acts to increase the sealing effectiveness of seal 50 to body 21 of coupling member 20 by increasing the pressure on sealing surface 78. The portion of seal body 70 immediately outboard and adjacent to the inner end of groove 76 may act as a “living hinge” or flexure bearing. In female coupling members having a seal cartridge, the outward, radial force acts to increase the sealing effectiveness of seal 50 to the seal cartridge. In female coupling members not having a seal retainer or seal cartridge (such as that illustrated in FIG. 1), the outward, radial force acts to increase the sealing effectiveness of seal 50 directly to the body of the female coupling member.

In negative pressure situations—i.e., wherein the pressure within the receiving chamber of the female coupling member is lower than the ambient pressure such as often occurs during probe withdrawal, the pressure differential creates an outward, radial force against the distal pressure-energized sealing surface 78, increasing the sealing effectiveness. The symmetry of seal 50 about its midline permits its installation in a female coupling member such as the one illustrated in FIG. 1 without regard to its orientation. This feature decreases the possibility of incorrect assembly of the coupling.

The enlarged view of FIG. 2A illustrates the various parameters of annular groove 76 and sealing surface 78. If seal 50 has a nominal outside diameter D₁, then portion P (which forms sealing surface 78) may have a varying diameter which, at a minimum is equal to D₁ and increases linearly to D₂ at the end surface of seal body 70. This increasing outside diameter in portion P may also be defined by angle A. Groove 76 has outside diameter D₃, width W and depth G. As shown in FIG. 2A, groove 76 is open to beveled surface 52.

Seal 50 may be fabricated of any suitable material. One particularly preferred material for probe seal 50 is polyetheretherketone (PEEK). Additional examples of suitable materials include DELRIN™ acetal resin engineering plastic, TEFLON™ polytetrafluoroethylene (PTFE), glass-filled PTFE, PEEK-filled PTFE, and similar, relatively soft, machinable polymers.

The various dimensions of seal 50 (including grooves 76 and 76′) may be varied to suit the particular coupling member in which it will be inserted and may also be dependent upon the material chosen for seal body 70. In one particular preferred embodiment, diameter D₂ provides a slight interference fit with the bore of female coupling member 20. Stated another way, sealing surface 78 may be pre-loaded by inserting seal 50 into a bore having an inside diameter slightly smaller than D₂.

By way of example only, in one particular preferred embodiment of seal 50 fabricated from PEEK and having a nominal outside diameter D₁ of 0.670 inch, diameter D₂ is about 0.680 inch; diameter D₃ is about 0.650 inch; dimension W is about 0.015 inch; dimension P is about 0.040 inch; and, dimension G is about 0.050 inch.

FIG. 3 shows a second embodiment of the pressure-energized probe seal. Seal 80 comprises the same elements as seal 50 (FIG. 2) but additionally has a pair of circumferential grooves 82,82′ in outer surface 81. O-rings 84,84′ or similar seals may be positioned in each of these grooves. O-rings 84,84′ may provide additional sealing effectiveness between the body of seal 80 and the body of female coupling member 20. In all other respects, seal 80 is interchangeable with seal 50.

FIG. 4 shows a third embodiment of the pressure-energized probe seal. Seal 90 comprises the same elements as seal 50 (FIG. 2) but additionally has a single circumferential groove 92 in outer surface 91. O-ring 94 or a similar seal may be positioned in this groove. O-ring 94 may provide additional sealing effectiveness between the body of seal 90 and the body of female coupling member 20. In all other respects, seal 90 is interchangeable with seal 50.

The illustrated embodiments all have bilateral symmetry. However, practice of the invention is not limited to seals having two, opposing, pressure-energized seals. A seal according to the invention could have a single groove 76 in one beveled end surface (and an un-grooved, beveled surface at the opposing end). In such a situation, it would be necessary to select the orientation of the seal in the body of the female coupling member. If the pressure-energized seal is on the distal end of the probe seal, sealing effectiveness is enhanced when ambient pressure exceeds the internal pressure (i.e., hydraulic fluid pressure). If, however, the pressure-energized seal is oriented towards the interior of the coupling member, sealing effectiveness is enhanced when hydraulic fluid pressure exceeds ambient pressure.

Probe seals according to the present invention may also be used in female coupling members which have seal retainers or seal cartridges. Probe seals according to the invention may be retrofitted to female coupling members having probe seals of the prior art.

Although the invention has been described in detail with reference to certain preferred embodiments, variations and modifications exist within the scope and spirit of the invention as described and defined in the following claims.

What is claimed is:

1. A probe seal for a female hydraulic coupling member comprising:
a generally ring-shaped body having a first end, an opposing second end, a generally cylindrical outer surface and a generally cylindrical inner surface;
an annular groove in at least one end of the ring-shaped body proximate the outer surface.

2. A probe seal as recited in claim 1 wherein the depth of the annular groove is at least about three times the width of the annular groove.

3. A probe seal as recited in claim 1 wherein the surface of the first end and the surface of the second end are disposed at an acute angle to the longitudinal axis of the generally ring-shaped body.

4. A probe seal as recited in claim 1 wherein the outside diameter of the probe seal is greater at the first end of the ring-shaped body than at the middle of the ring-shaped body.

5. A probe seal as recited in claim 1 wherein the outside diameter of the probe seal is greater at the first end and second end of the ring-shaped body than at the middle of the ring-shaped body.

6. A probe seal as recited in claim 1 having an annular groove in each end of the generally ring-shaped body.

7. A probe seal as recited in claim 1 wherein the ring-shaped body comprises an elastomer.

8. A probe seal as recited in claim 1 wherein the ring-shaped body is fabricated from a material selected from the group consisting of: polyetheretherketone (PEEK); acetal resins; polytetrafluoroethylene (PTFE); glass-filled PTFE; and, PEEK-filled PTFE.

9. A probe seal as recited in claim 1 wherein the ring-shaped body consists of an engineering plastic.

10. A probe seal as recited in claim 1 further comprising a circumferential groove in the generally cylindrical outer surface.

11. A probe seal as recited in claim 1 further comprising a pair of circumferential grooves in the generally cylindrical outer surface and an O-ring seal in each of the grooves.

12. A female hydraulic coupling member comprising:
a generally cylindrical body having a central axial bore;
a shoulder within the central axial bore disposed at an acute angle to the longitudinal axis of the generally cylindrical body;
a probe seal within the central axial bore having a generally ring-shaped body with a first end abutting the shoulder within the central axial bore, an opposing second end, a generally cylindrical outer surface and a generally cylindrical inner surface and an annular groove in at least one end of the ring-shaped body proximate the outer surface.

13. A female hydraulic coupling member as recited in claim 12 wherein the depth of the annular groove in the probe seal is at least about three times the width of the annular groove in the probe seal.

14. A female hydraulic coupling member as recited in claim 12 wherein the surface of the first end and the surface of the second end of the probe seal are disposed at an acute angle to the longitudinal axis of the generally ring-shaped body.

15. A female hydraulic coupling member as recited in claim 12 wherein the outside diameter of the probe seal is greater at the first end of the ring-shaped body than at the middle of the ring-shaped body.

16. A female hydraulic coupling member as recited in claim 12 wherein the outside diameter of the probe seal is greater at the first end and second end of the ring-shaped body than at the middle of the ring-shaped body.

17. A female hydraulic coupling member as recited in claim 12 having an annular groove in each end of the generally ring-shaped body of the probe seal.

18. A female hydraulic coupling member as recited in claim 12 wherein the ring-shaped body of the probe seal comprises an elastomer.

19. A female hydraulic coupling member as recited in claim 12 wherein the ring-shaped body of the probe seal is fabricated from a material selected from the group consisting of: polyetheretherketone (PEEK); acetal resins; polytetrafluoroethylene (PTFE); glass-filled PTFE; and, PEEK-filled PTFE.

20. A female hydraulic coupling member as recited in claim 12 wherein the ring-shaped body of the probe seal consists of an engineering plastic.

21. A female hydraulic coupling member as recited in claim 12 further comprising a circumferential groove in the generally cylindrical outer surface of the probe seal.

22. A female hydraulic coupling member as recited in claim 12 further comprising a pair of circumferential grooves in the generally cylindrical outer surface of the probe seal and a seal in each of the grooves.

23. A female hydraulic coupling member as recited in claim 22 wherein the seal in each of the grooves is an O-ring seal.
